(19) United States
(12) Patent Application Publication
(10) Pub. No.: US 2026/0085747 A1
(43) Pub. Date: Mar. 26, 2026

(54) ELECTRIC AXLE AND ELECTRIC AXLE PRODUCT LINE

(71) Applicant: Dana Automotive Systems Group, LLC, Maumee, OH (US)

(72) Inventors: Darren J. ZISKOVSKY, Bowling Green, OH (US); Eric M. ENGERMAN, Plymouth, MI (US); Ryan D. NELMS, Weatherford, TX (US); Benjamin POWELL, Austin, TX (US)

(21) Appl. No.: 18/894,602

(22) Filed: Sep. 24, 2024

(51) Int. Cl. F16H 37/08; B60K 1/00; B60K 17/08; B60K 17/16; F16H 57/02; F16H 57/031; F16H 57/037; F16H 57/04

(52) U.S. Cl. CPC F16H 37/082; B60K 1/00; B60K 17/08; B60K 17/165; F16H 57/031; F16H 57/037; F16H 57/0415; F16H 57/0476; F16H 57/0483; F16H 57/0484; B60K 2001/001; B60K 2001/006; F16H 2057/02034; F16H 2057/02052; F16H 2200/0021; F16H 2200/2005

(57) ABSTRACT

A system and method for an electric axle. The electric axle includes, in one example, a traction motor and an input planetary gear set arranged coaxial to the traction motor. The input planetary gear set includes a sun gear rotationally coupled to the traction motor, a carrier including a first section coupled to multiple carrier shafts and a second section removably coupled to the multiple carrier shafts, and multiple planet gears rotationally mounted on the multiple carrier shafts. The electric axle further includes a differential coupled to the downstream component and in the electric axle, the differential is positioned parallel to and offset from the traction motor, the second section is rotationally coupled to a downstream component and the downstream component is arranged coaxial to the input planetary gear set.

### TECHNICAL FIELD

The present disclosure relates to an electric axle and axle product line with a modular architecture.

### BACKGROUND AND SUMMARY

Segments of the vehicle market are moving towards electrification. The inventors have recognized a need to further increase electric powertrain compactness and power output in a cost effective package. Attempts have been made to develop electric axles for hybrid and all-electric vehicle platforms. Electric axles include motors, gear trains, and differentials that are packaged together for delivering power to drive wheels.

The inventors have recognized the abovementioned challenges and developed an electric axle system to at least partially overcome the challenges. The electric axle system includes, in one example, a traction motor and an input planetary gear set arranged coaxial to the traction motor. The input planetary gear set includes a sun gear rotationally coupled to the traction motor, a carrier that includes a first section coupled to multiple carrier shafts and a second section that is removably coupled to the multiple carrier shafts, and multiple planet gears that are rotationally mounted on the multiple carrier shafts. The electric axle system further includes a differential coupled to the downstream component. In the electric axle system, the differential is positioned parallel to and offset from the traction motor. Further, in the electric axle system, the second section is rotationally coupled to a downstream component. Even further, in the electric axle system, the downstream component is arranged coaxial to the input planetary gear set. In this way, a modular electric axle architecture is achieved in a space efficient layout that is able to be incorporated into a wider variety of vehicle platforms, thereby increasing customer appeal.

In one example, the downstream component is a multi-speed planetary gear set. In this way, the modularity of the electric axle is leveraged to provide shifting functionality that allows for more efficient operation of the electric machine.

In another example, the downstream component is an output gear. In this way, the electric axle achieves a desired gear reduction ratio in a more compact package.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIGS. 1-4 show different electric axle architectures where each of the electric axles includes an input planetary gear set.

FIGS. 5-7 show different views of a detailed example of an electric axle with an input planetary gear set and a multi-speed planetary gear set.

FIGS. 8-10 show different views of another detailed example of an electric axle with an input planetary gear set and an output gear.

FIGS. 11-12 show detailed examples of carriers for an input planetary gear set.

FIGS. 13-14 show different modular electric axle architectures.

FIGS. 15-16 show different exemplary cooling system architectures for the electric axles.

### DETAILED DESCRIPTION

A modular family of electric axles is described herein that allows for interchangeability of parts and components. The modular product line allows the electric powertrains to utilize various length motors, various overall gear ratios, single and multispeed architectures, as well as various differential designs to meet different vehicle platform demands. The modular electric axle product line allows for reuse of components across different applications, but also allows for the flexibility to customize the electric axles for specific applications. The electric axles include a section with an electric motor, an input planetary gear set, an output gear, a differential that is offset from the motor and input planetary gear set, and an optionally a multi-speed planetary gear set. The lateral location of the output gear and/or the multi-speed planetary gear set may be switched between the different positions based on the end-use design goals of the vehicle platform in which the axle is being integrated, due to the modularity of the electric axle product line expanded upon herein.

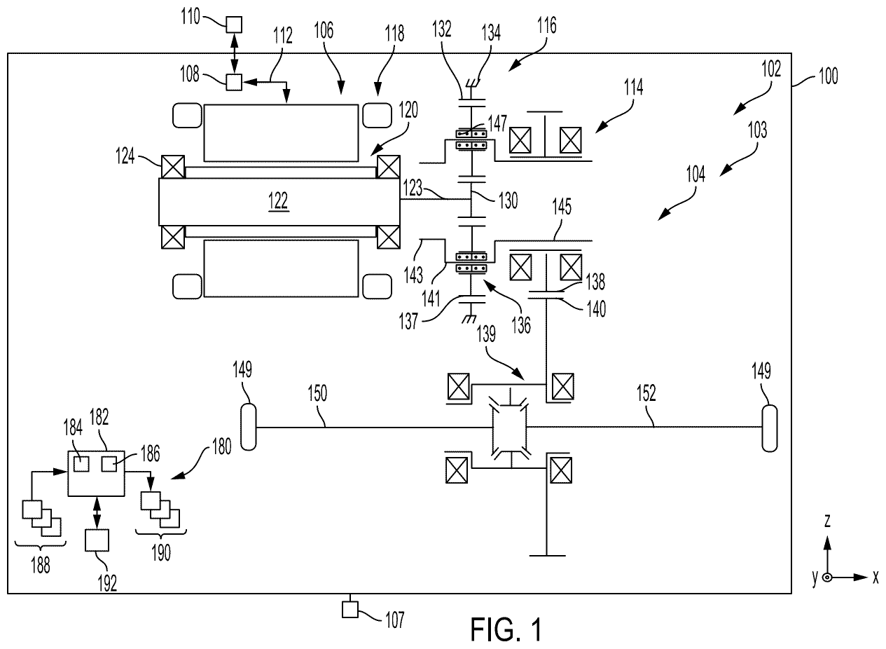

FIG. 1 shows an electric vehicle (EV) 100 that includes a powertrain 102 with an electric axle assembly 103 with an electric axle 104 (e.g., a rear electric axle, in one example). As such, The EV 100 may be an all-electric EV (e.g., battery electric vehicle (BEV)) or a hybrid EV in the different example. The other electric axles described herein may be rear axles. Further, in some examples the other axle may be driven by an internal combustion engine (ICE). However, in other examples, the ICE may be configured to charge a traction battery and/or other suitable energy storage device.

As described herein an electric axle is an electric drive incorporated into an axle. The electric axle may be an electric beam axle, in one example. A beam axle is an axle with mechanical components structurally supporting one another and extending between drive wheels. For instance, the beam axle may be a structurally continuous structure that spans the drive wheels on a lateral axis, in one embodiment. Thus, wheels coupled to the beam axle substantially move in unison when articulating, during, for example, vehicle travel on uneven road surfaces. To elaborate, the camber angle of the wheels may remain substantially constant as the suspension moves through its travel. The beam axle may be coupled to a dependent suspension system 107, in one example. Therefore, the electric axle may be an unsprung mass.

The electric axle 104 includes an electric machine 106 (e.g., a traction motor). The electric machine 106 may be an electric motor-generator, for example. For instance, the electric machine 106 may be designed as a multi-phase alternating current (AC) motor-generator. However, in other examples, the electric machine may be a motor without generator capabilities.

As illustrated in FIG. 1, the electric machine 106 may be electrically coupled to an inverter 108. The inverter 108 is designed to convert direct current (DC) electric power to alternating current (AC) electric power and vice versa. Therefore, the electric machine 106 may be an AC electric machine, as previously indicated. However, in other examples, the electric machine may be a DC electric machine and the inverter may therefore be omitted from the electric drive, in such an example. The inverter 108 may receive electric energy from one or more energy storage device(s) 110 (e.g., traction batteries, capacitors, combinations thereof, and the like). Arrows 112 signify the electric energy transfer between the electric machine 106, the inverter 108, and the energy storage device(s) 110 that may occur during different modes of electric axle operation (e.g., a drive mode and a regeneration mode). As such, during a drive mode, electric energy may flow from the energy storage device(s) 110 to the electric machine 106 and during a regenerative mode, electric energy may flow in the opposite direction from the electric machine to the energy storage device(s). The inverter 108 may be integrated into the electric axle 104, in one example, as discussed in greater detail herein.

The electric axle 104 further includes a gear train 114 that is coaxially arranged with the electric machine 106, thereby enabling the electric axle to achieve a space efficient package that is able to be more easily integrated into a wider variety of vehicle platforms. The gear train 114 includes an input planetary gear set 116. Specifically, in the illustrated example, the input planetary gear set 116 is a simple planetary gear set. A simple planetary gear set is a planetary gear set that solely includes a ring gear, a set of planet gears, a carrier, and a sun gear. To elaborate, as described herein a simple planetary gear set is a planetary gear set with solely a ring gear, a sun gear, a carrier, and multiple planet gears that are in the same plane as the ring gear and the sun gear and rotate on the carrier. Further, in the simple planetary gear set, each planet gear meshingly engages both the sun gear and the ring gear. However, in other examples, the input gear set may be a different type of planetary gear set such as a compound planetary gear set.

The electric machine 106 includes a stator 118 and a rotor 120 that includes a rotor shaft 122. The rotor shaft 122 is either directly coupled to the input planetary gear set 116 or coupled to the input planetary gear set using an intermediary shaft. Bearings 124 are coupled to the rotor shaft 122 and enable rotation thereof. An input shaft 123 (for the gear train) is rotationally coupled to the rotor shaft 122, in the illustrated example. However, in other examples, the rotor shaft may be designed with an extension for gear train attachment.

The input planetary gear set 116 includes a sun gear 130 that is rotationally coupled (e.g., directly rotationally coupled) to the input shaft 123. In the illustrated example, a ring gear 132 in the input planetary gear set 116 is mechanically grounded via a stationary component 134 such as a housing or other suitable component. A carrier 136 is coupled to a downstream component, in the illustrated example. In this way, the input planetary gear set achieves a desired gear reduction ratio. However, in other examples, another component in the input planetary gear set may be coupled to the downstream component. Specifically, the downstream component is an output gear 138, in the illustrated example. Planet gears 137 are rotatably mounted to carrier shafts 141 via bearings 147 (e.g., needle roller bearings). The carrier 136 is constructed of separate sections which are removably attached to one another. To elaborate, an upstream section 143 of the carrier 136 may be coupled to the carrier shafts 141. The upstream section 143 may be rotatably supported via one or more bearings. Further, a downstream section 145 of the carrier 136 is rotationally coupled to the output gear 138. The other carriers described herein may similarly include carrier shafts, an upstream section, and a downstream section that are removably attached to one another. Some of these sections may have similar size and profile to simplify manufacturing. However, the downstream sections may be structurally modified to fit different electric axle architectures and increase the modularity of a product line in which the electric axles are included.

In the illustrated example, the output gear 138 is rotationally coupled to a differential 139. To elaborate, the output gear 138 meshes with an input gear 140 of the differential 139.

The differential 139 may be an open differential, a locking differential, or a torque-sensing limited-slip differential in different examples. However, other suitable types of differentials may be used in the electric axle 104 in other examples.

Axle shafts 150 and 152 are rotationally coupled to the differential 139. In turn drive wheels 149 are rotationally coupled to the axle shafts 150 and 152. In certain examples, when end gear reductions may be coupled to the axle shafts.

The EV 100 may also include a control system 180 with a controller 182. The controller 182 includes a processor 184 and memory 186. The memory 186 holds instructions stored therein that when executed by the processor 184 cause the controller 182 to perform the various methods, control techniques, etc., described herein. The processor 184 may include a microprocessor unit and/or other types of circuits. The memory 186 includes known data storage mediums such as random access memory, read only memory, keep alive memory, combinations thereof, and the like.

The controller 182 may receive various signals from sensors 188 positioned in different locations in the EV 100 and the multi-speed electric axle 104, more specifically. The sensors may include an electric machine speed sensor, energy storage device temperature sensor(s), clutch position sensors, an energy storage device state of charge sensor(s), wheel speed sensors, and the like. The controller 182 may also send control signals to various actuators 190 coupled at different locations in the EV 100, and the multi-speed electric axle 104. For instance, the controller 182 may send signals to the inverter 108 to adjust the rotational speed of the electric machine 106. The other controllable components in the vehicle and powertrain may function in a similar manner with regard to command signals and actuator adjustment. For instance, the controller 182 may send signals to the inverter 108 to adjust the speed of the electric machine 106. The controller and control system shown in FIG. 1 may be used in the other electric axle examples described herein. The controller may further be configured to send shift commands to a clutch to shift between operating gears when the electric axle includes a multi-speed gear train. The control system may be used in any of the electric axles described herein for component control.

The EV 100 may also include one or more input device(s) 192 (e.g., an accelerator pedal, a brake pedal, a gear selector, a differential locker actuator, a console instrument panel, a touch interface, a touch panel, a keyboard, combinations thereof, and the like) in electronic communication with the controller 182. The input device(s) 192, responsive to operator input, may generate an acceleration adjustment request, a gear shift request when the electric axle includes a multi-speed gear train, and the like.

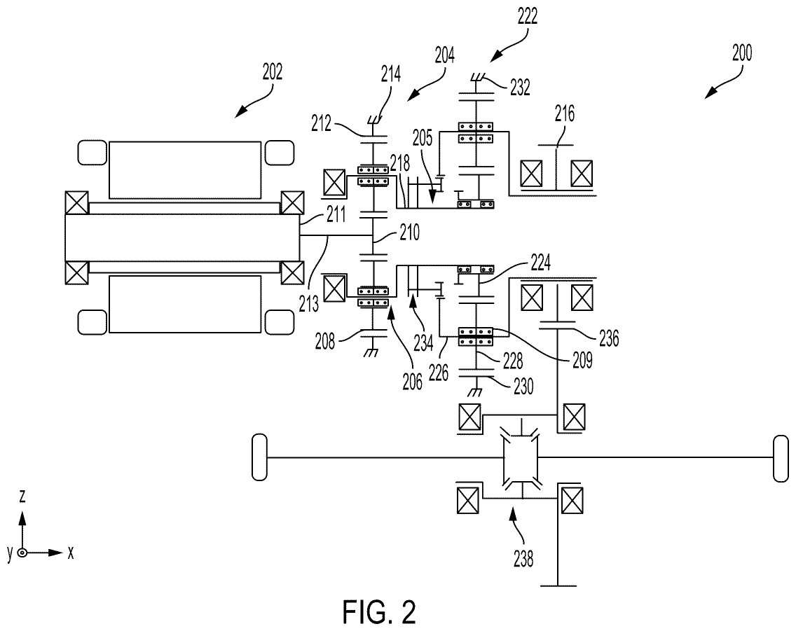

An axis system is provided in FIG. 1 as well as FIGS. 2-14, for reference, when appropriate. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

FIG. 2 shows another example of an electric axle 200 (e.g., a rear electric axle, in one example). The electric axle 200 again includes an electric machine 202 and an input planetary gear set 204. The electric machine 202 may have a similar size and construction to the electric machine 106 shown in FIG. 1. However, in other examples, a different type of motor with regard to size and/or profile may be used in the electric axle 200.

Further, the input planetary gear set 204 may have a similar size and construction to the input planetary gear set 116 aside from a downstream section 205 of a carrier 206 which is removably coupled to the carrier shafts on which a set of planet gears 208 are rotatably mounted. To elaborate, the sun gears, the planet gears, the carrier shafts, the ring gears, and the sun gears are identical in size and structure in the input planetary gear set 116 and the input planetary gear set 204. Thus, the input planetary gear set 204 includes a sun gear 210. The sun gear 210 is rotationally coupled to the electric machine 202. The input planetary gear set 204 further includes a ring gear 212 that is again grounded using a stationary component 214, the carrier 206, and the set of planet gears 208 that are rotatably mounted on the carrier 206 via bearings 209 (e.g., needle bearings). Again, a rotor shaft 211 in the electric machine 202 is rotationally coupled to an input shaft 213 that is rotationally coupled to the sun gear 210.

The electric axle 200 again includes an output gear 216 that may have a similar size and structure to the output gear 138, shown in FIG. 1, aside from a downstream portion 218 of the carrier 206 that is rotationally coupled to a clutch 234 which is in turn rotationally coupled to a multi-speed planetary gear set 222 which are described in greater detail below.

The multi-speed planetary gear set 222 includes a sun gear 224, a carrier 226, a set of planet gears 228 that are rotatably mounted on the carrier 226, and a ring gear 230. In the illustrated example, the ring gear 230 is mechanically grounded via a stationary component 232.

To achieve the multi-speed functionality, the multi-speed planetary gear set 222 includes a clutch 234. In a first position the clutch 234 rotationally couples the carrier 206 to the sun gear 224. In a second position the clutch 234 rotationally couples the carrier 206 to the carrier 226. The output gear 216 again is rotationally coupled to an input gear 236 of a differential 238. The differential 238 may have a similar construction to the differential 139 depicted in FIG. 1.

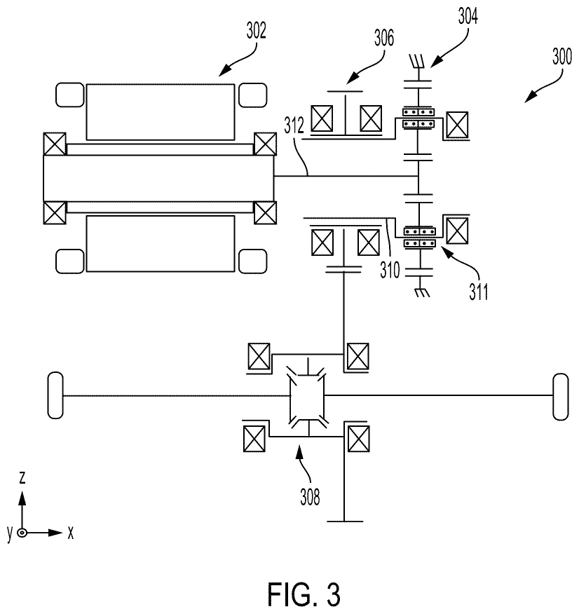

FIG. 3 shows another electric axle 300 (e.g., a rear electric axle, in one example). In the illustrated example, the electric axle 300 again includes an electric machine 302, an input planetary gear set 304, and an output gear 306. The electric machine 302 may have a similar construction to the electric machines 106 and 202 shown in FIGS. 1 and 2, respectively.

FIG. 3 further shows a differential 308 (e.g., an open differential) that is rotationally coupled to the output gear. When compared to the electric axle 104 shown in FIG. 1, the electric axle 300 has the output gear 306 arranged laterally between the electric machine 302 and the input planetary gear set 304 as opposed to the output gear 138 that is arranged laterally outboard of the input planetary gear set 116, as shown in FIG. 1. To achieve this variance, the input planetary gear set 304 includes a downstream carrier section 310 in a carrier 311 that allows the output gear 306 to be positioned laterally between the electric machine 302 and the input planetary gear set 304. A length of an input shaft 312 is increased and the carrier section 310 is positioned laterally inboard of the input planetary gear set 304 to allow the output gear 306 to be positioned laterally between the electric machine 302 and the input planetary gear set 304. In this way, the modularity of the electric axle can be leveraged for integration of the axle into different vehicle platforms.

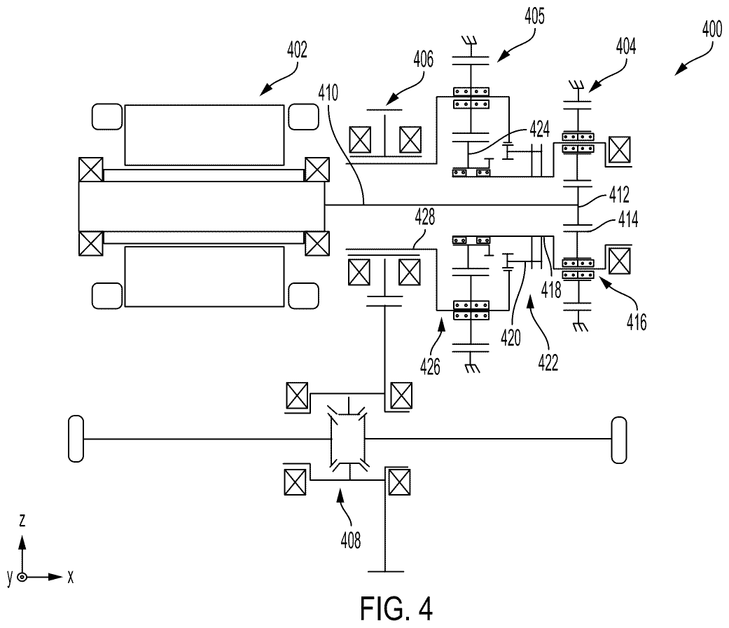

FIG. 4 shows another electric axle 400 (e.g., a rear electric axle, in one example). In the illustrated example, the electric axle 400 again includes an electric machine 402, an input planetary gear set 404, a multi-speed planetary gear set 405, and an output gear 406. The electric machine 302 may have a similar construction to the electric machines 106 and 202 shown in FIGS. 1 and 2 respectively.

FIG. 4 further shows a differential 408 (e.g., an open differential) that is rotationally coupled to the output gear. When compared to the electric axle 104 shown in FIG. 2, the electric axle 300 has the output gear 406 arranged laterally between the electric machine 402 and the multi-speed planetary gear set 405. In this way, the lateral compactness of the axle is increased when compared to the multi-speed electric axle 200 depicted in FIG. 2. To achieve this output gear position, an input shaft 410 is lengthened with regard to the electric axles shown in FIGS. 1-3. Further, the input planetary gear set 404 is positioned laterally outboard from the multi-speed planetary gear set 405, in the illustrated example. The input shaft 410 is again rotationally coupled to a sun gear 412 of the input planetary gear set 404. Planet gears 414 mesh with the sun gear 412 and are rotationally mounted on a carrier 416. The carrier 416 includes a downstream section 418 that is rotationally coupled to a section 420 of a clutch 422. Again, the clutch 422, in a first position, rotationally couples the carrier 416 to a sun gear 424 in the multi-speed planetary gear set 405. In a second position, the clutch 422 rotationally couples the carrier 416 to a carrier 426 in the multi-speed planetary gear set 405. The carrier 426 includes a downstream section 428 that is rotationally coupled to the output gear 406.

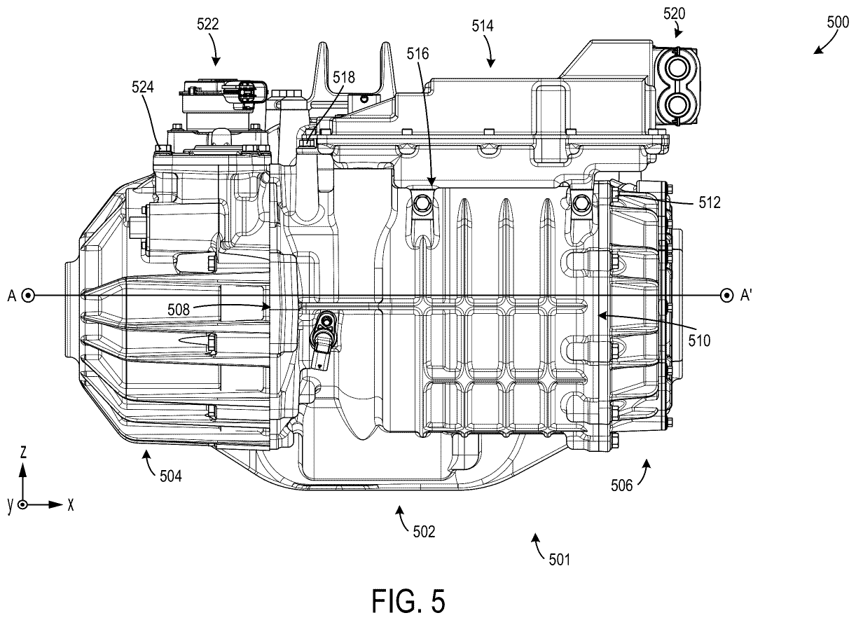

FIGS. 5-7 show a detailed example of an electric axle 500 that has a component architecture that corresponds to the electric axle 400 depicted in FIG. 4. As such, the electric axle 500 includes an electric machine, an input planetary gear set, a multi-speed planetary gear set, and an output gear that are at least partially enclosed within a housing 501.

FIG. 5 specifically shows a top view of the electric axle 500 with the housing 501. The housing 501 may be divided into sections that are removably attached to one another. To expound, the housing 501 includes a body 502 with end covers 504 and 506 that are attached to opposing lateral sides 508 and 510 of the body. However, other housing configurations may be used in other examples. Bolts 512 and/or other suitable attachment devices may be used to attach the end covers 504 and 506 to the body 502 of the housing 501.

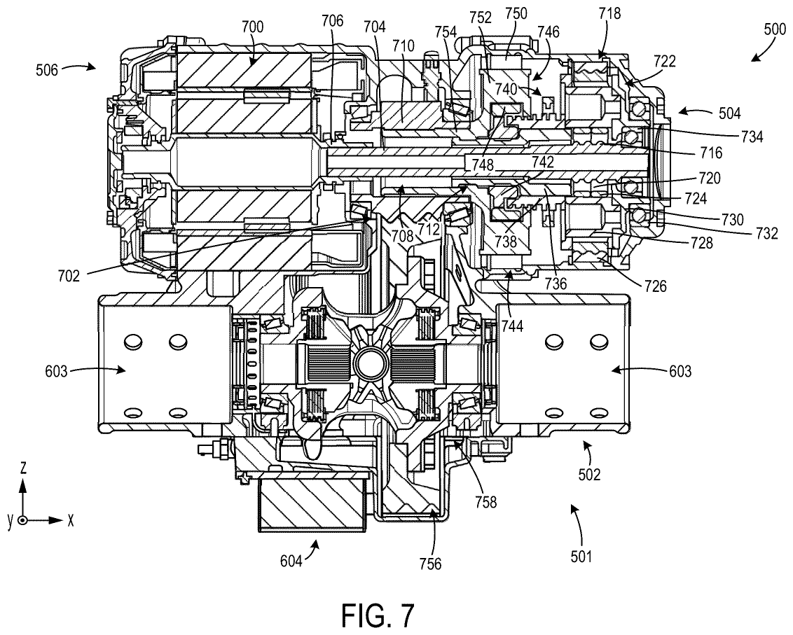

An inverter 514 is coupled to a longitudinal side 516 of the body 502, in the illustrated example. However, the inverter may be coupled to other sections of the housing, in other examples. Bolts 518 and/or other suitable attachment devices may be used to removably attach the inverter 514 to the housing 501. The inverter 514 includes an electrical interface 520 that allows the inverter to be electrically coupled to an energy storage device (e.g., a traction battery). The electrical interface 520 may be configured to electrically connect to high voltage (HV) DC cables. A clutch actuator 522 may further be coupled to the housing 501. To elaborate, the clutch actuator 522 may be removably coupled to the end cover 504 via bolts 524 and/or other suitable attachment devices. A cutting plane A-A′ corresponding to the cross-sectional view depicted in FIG. 7 is provided in FIG. 5, for reference.

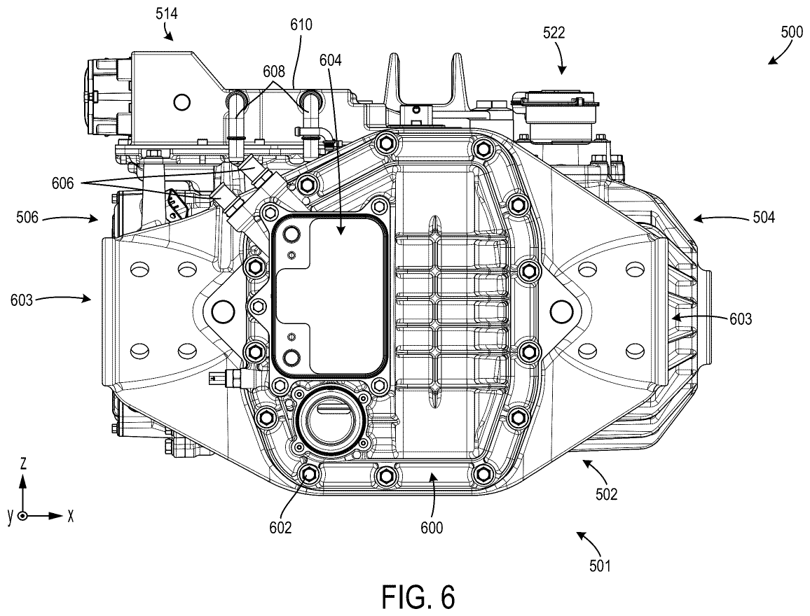

FIG. 6 shows a bottom view of the electric axle 500. The housing 501 with the body 502 and the end covers 504 and 506 are again depicted. The housing 501 further includes a differential cover 600 removably coupled to the body 502 via attachment devices 602 or other suitable techniques. In this way, the differential may be efficiently accessed during axle maintenance and repair. The body 502 includes axle shaft openings 603, in the illustrated example.

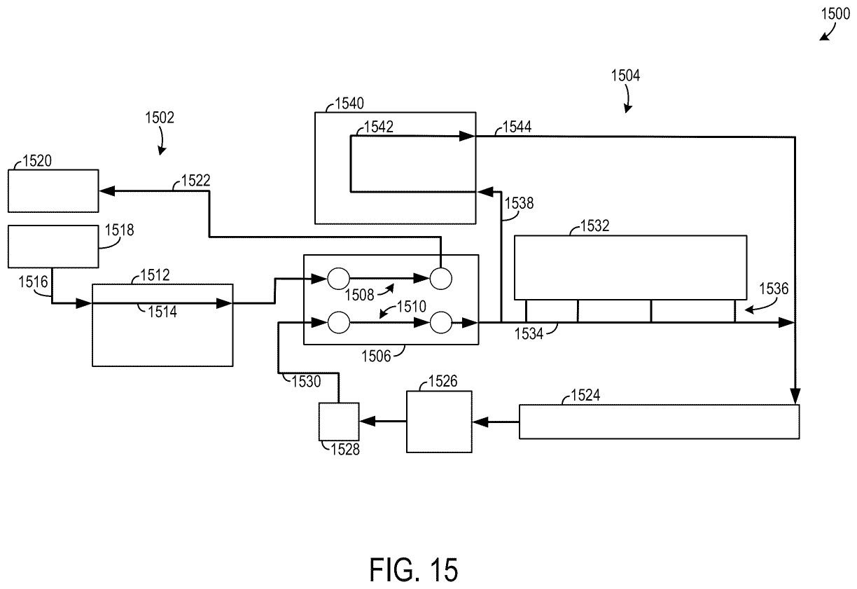

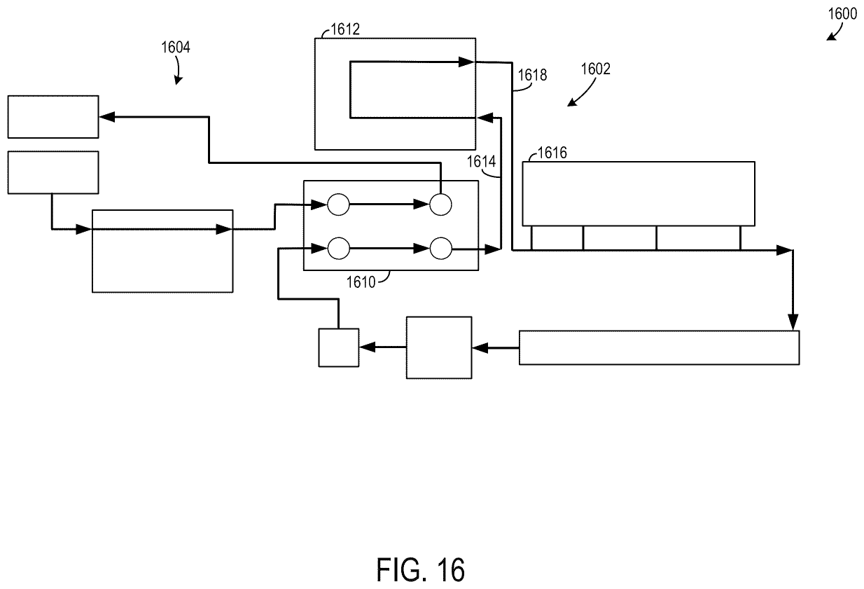

A heat exchanger 604 is coupled to the differential cover 600 in the illustrated example. The heat exchanger 604 is designed to remove heat from a coolant that is circulated through the electric axle. The heat exchanger 604 includes coolant ports 606 that circulate water ethylene glycol (WEG) or other suitable coolant mixture therethrough. The heat exchanger 604 may further be configured to circulate oil therethrough. Therefore, the electric axle 500 as well as the other electric axles described herein may include a coolant (e.g., WEG) circulation subsystem and/or an oil circulation subsystem. The oil may be designed to provide both cooling (and lubrication, in some instance) to desired electric axle components. FIGS. 15-16 show different cooling system architectures that may be used in any of the electric axles described herein or combinations of the electric axles.

FIG. 15 specifically shows an exemplary electric axle cooling system 1500 with a WEG loop 1502 and an oil loop 1504. Both the WEG loop 1502 and the oil loop 1504 route their working fluid through a heat exchanger 1506. To elaborate, the heat exchanger 1506 includes a WEG conduit, manifold, combinations thereof, and the like (indicated at 1508) and an oil conduit, manifold, combinations thereof, and the like (indicated at 1510). The oil and WEG flow through the heat exchanger 1506 in a parallel configuration in the illustrated example. However, numerous heat exchanger designs are possible such as a counterflow heat exchanger. In the illustrated example, WEG is routed through the inverter 1512 as denoted via a WEG conduit 1514. A WEG line 1516 routes WEG from a WEG source 1518 to the inverter 1512. From the heat exchanger 1506, WEG is routed to a WEG return 1520 via a WEG line 1522, in the illustrated example. The WEG source 1518 may be a WEG pump and/or a vehicle radiator. It will be understood that in some examples, the WEG loop may be used to warm oil in the oil loop during a cold condition by routing the WEG through battery packs and/or other heat generating vehicle systems.

An oil sump 1524 that may include a filter is included in the oil loop 1504. An oil pump 1526 and an oil filter 1528 are included in the oil loop 1504, in the illustrated example. From the oil filter 1528, oil is routed to the heat exchanger 1506 via an oil line 1530, in the illustrated example. From the heat exchanger oil is routed to a gear train 1532 via oil line 1534. Oil may be passively routed to gear train components (e.g., an input planetary gear set, a multi-speed planetary gear set, and the like) via conduits, lines, etc. as indicated at 1536. An oil line 1538 routes oil from the heat exchanger 1506 to a traction motor 1540. To elaborate, oil is routed through the traction motor as indicated at 1542 and then routed to the sump 1524 via an oil line 1544. The oil line 1534 is fluidly connected to the oil line 1544, downstream of the gear train 1532. In this way, oil is routed through the gear train 1532 and the traction motor 1540 in parallel. However, as shown in FIG. 16, oil is routed from a heat exchanger 1610 to a traction motor 1612 via an oil line 1614 and then routed to a gearbox 1616 from the traction motor via oil line 1618. In this way, oil may be routed through the traction motor and the gearbox in series. However, the other components in the electric axle cooling system 1600 with an oil loop 1602 and a WEG loop 1604 are similar to the components in the electric axle cooling system 1500, shown in FIG. 15. Therefore, redundant description of the overlapping components is omitted for brevity. It will be appreciated that the cooling system architectures shown in FIGS. 15-16 are exemplary in nature and other suitable architectures may be used in any of the electric axles described herein.

FIG. 6 shows the inverter 514 with coolant ports 608. Further, a face 610 of the inverter 514 may be parallel to the x-y plane, in one example. In this way, the inverter 514 is space efficiently incorporated into the electric axle 500.

FIG. 7 shows a cross-sectional view of the electric axle 500. The housing 501 with the body 502 and the end covers 504 and 506 is again shown. The electric axle 500 includes an electric machine 700 (e.g., a traction motor) that is rotationally coupled to a gear train 702. To elaborate, an input shaft 704 in the gear train 702 is rotationally coupled to a rotor shaft 706 in the electric machine 700.

The input shaft 704 extends through an opening 708 in an output gear 710 and an opening 712 in a multi-speed planetary gear set 744. Further, the input shaft 704 is rotationally coupled to a sun gear 716 in an input planetary gear set 718, in the illustrated example. To elaborate, the sun gear 716 may be integrally formed with the input shaft 704, splined to the input shaft, or welded to the input shaft.

The input planetary gear set 718 is a simple planetary gear set, in the illustrated example. In this way, the compactness of the electric axle is increased, when compared to electric axle that use more complex planetary gear sets. However, other types of planetary gear sets may be used as the input gear set in the gear train in other examples.

The input planetary gear set 718 includes planet gears 720 that are rotatably mounted to a carrier 722 via bearings 724 (e.g., needle bearings). The input planetary gear set 718 further includes a ring gear 726 that is grounded by the housing 501, in the illustrated example. Specifically, the end cover 504 grounds the ring gear 726. However, the body may ground the ring gear, in other examples. The carrier 722 is divided into several sections that are removably attached to one another. To elaborate, the carrier 722 includes carrier shafts 728 on which the planet gears 720 are rotatably mounted, a section 730 that is arranged on an outboard side of the input planetary gear set 718 and coupled to bearings 732 and 734 that are coupled to the housing 501 and the input shaft 704, respectively. The carrier 722 further includes a downstream section 736 that is removably coupled to the carrier shafts 728. The downstream section 736 is rotationally coupled to a section 738 of a clutch 740.

The clutch 740 is configured to rotationally couple the carrier 722 to a sun gear 742 in the multi-speed planetary gear set 744, in a first position. Additionally, the clutch 740 is configured to rotationally couple the carrier 722 to a carrier 746 in the multi-speed planetary gear set 744. The clutch 740 may also be designed to be arranged in a neutral position where the input planetary gear set 718 is decoupled from the multi-speed planetary gear set 744, in one example. The multi-speed planetary gear set 744 further includes planet gears 748 that are rotatably mounted to the carrier 746. The multi-speed planetary gear set 744 further includes a ring gear 750 that is grounded by the housing 501, in the illustrated example.

The carrier 746 includes multiple removably attached sections. To expound, the carrier 746 includes carrier shafts 752 and a downstream section 754 removably attached thereto. The downstream section 754 of the carrier 746 is rotationally coupled to the output gear 710 via splined engagement and/or other suitable techniques. The output gear 710 meshes with an input gear 756 of a differential 758. The heat exchanger 604 is further depicted in FIG. 6. The end cover 506 provide efficient access to the electric machine 700.

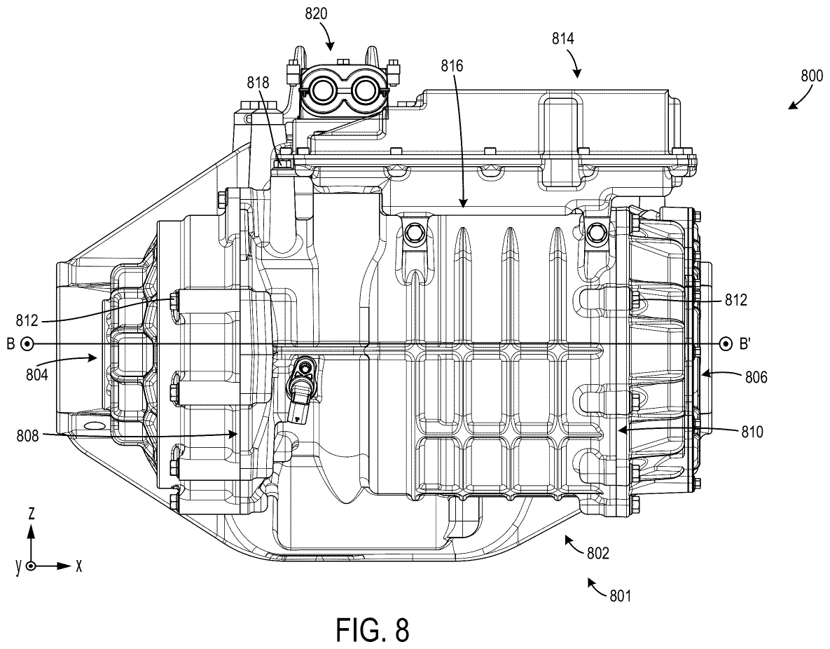

FIGS. 8-10 show a detailed example of an electric axle 800 that has a component architecture that corresponds to the electric axle 300 depicted in FIG. 3. As such, the electric axle 800 includes an electric machine, an input planetary gear set, and an output gear that are at least partially enclosed within a housing 801.

FIG. 8 specifically shows a top view of the electric axle 800 with the housing 801. The housing 801 may be divided into sections that are removably attached to one another. To expound, the housing 801 includes a body 802 with end covers 804 and 806 that are attached to opposing lateral sides 808 and 810 of the body. However, other housing configurations may be used in other examples. Bolts 812 and/or other suitable attachment devices may be used to attach the end covers 804 and 806 to the body 802 of the housing 801.

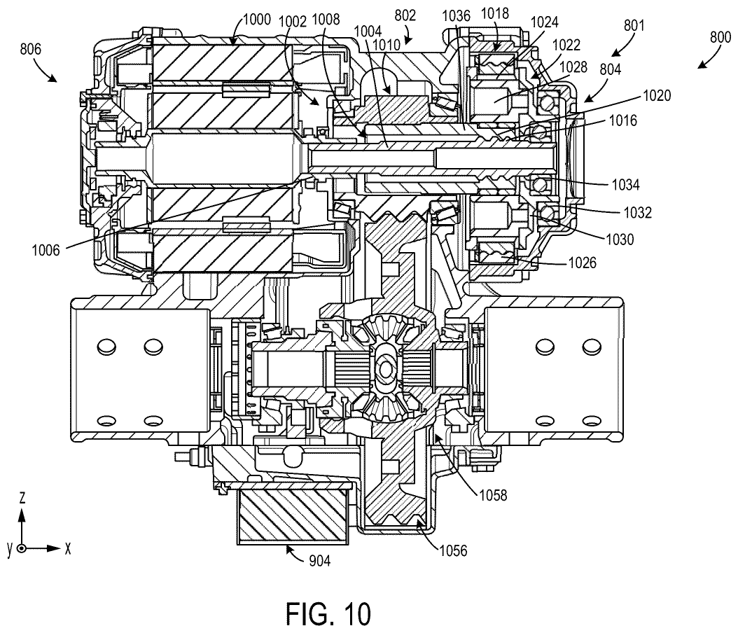

An inverter 814 is coupled to a longitudinal side 816 of the body 802, in the illustrated example. However, the inverter may be coupled to other sections of the housing, in other examples. Bolts 818 and/or other suitable attachment devices may be used to removably attach the inverter 814 to the housing 801. The inverter 814 includes an electrical interface 820 that allows the inverter to be electrically coupled to an energy storage device (e.g., a traction battery). The electrical interface 820 may be configured to electrically connect to high voltage (HV) DC cables. A cutting plane B-B′ corresponding to the cross-sectional view depicted in FIG. 10 is provided in FIG. 8, for reference.

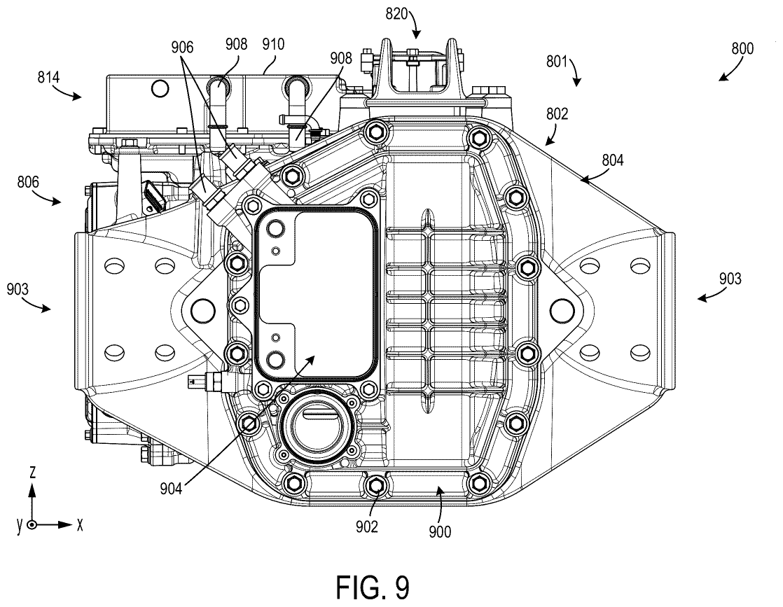

FIG. 9 shows a bottom view of the electric axle 800. The housing 801 with the body 802 and the end covers 804 and 806 are again depicted. The housing 801 further includes a differential cover 900 removably coupled to the body 802 via attachment devices 902 or other suitable techniques. In this way, the differential may be efficiently accessed during axle maintenance and repair. The body 802 includes axle shaft openings 903, in the illustrated example.

A heat exchanger 904 is coupled to the differential cover 900 in the illustrated example. The heat exchanger 904 is designed to remove heat from a coolant that is circulated through the electric axle. The heat exchanger 904 includes coolant ports 906.

FIG. 9 shows the inverter 814 with coolant ports 908. Further, a face 910 of the inverter 814 may be parallel to the x-y plane, in one example. In this way, the inverter 814 is space efficiently incorporated into the electric axle 800. The electrical interface 820 of the inverter 814 is again shown in FIG. 9.

FIG. 10 shows a cross-sectional view of the electric axle 800. The housing 801 with the body 802 and the end covers 804 and 806 is again shown. The electric axle 800 includes an electric machine 1000 (e.g., a traction motor) that is rotationally coupled to a gear train 1002. To elaborate, an input shaft 1004 in the gear train 1002 is rotationally coupled to a rotor shaft 1006 in the electric machine 1000.

The input shaft 1004 extends through an opening 1008 in an output gear 1010. Further, the input shaft 1004 is rotationally coupled to a sun gear 1016 in an input planetary gear set 1018, in the illustrated example. To elaborate, the sun gear 1016 may be integrally formed with the input shaft 1004, splined to the input shaft, or welded to the input shaft.

The input planetary gear set 1018 is a simple planetary gear set, in the illustrated example. In this way, the compactness of the electric axle is increased, when compared to electric axle that use more complex planetary gear sets. However, other types of planetary gear sets may be used as the input gear set in the gear train in other examples.

The input planetary gear set 1018 includes planet gears 1020 that are rotatably mounted to a carrier 1022 via bearings 1024 (e.g., needle bearings). The input planetary gear set 1018 further includes a ring gear 1026 that is grounded by the housing 801, in the illustrated example. Specifically, the end cover 804 grounds the ring gear 1026. However, the body may ground the ring gear in other examples. The carrier 1022 is divided into several sections that are removably attached to one another. To elaborate, the carrier 1022 includes carrier shafts 1028 on which the planet gears 1020 are rotatably mounted, a section 1030 that is arranged on an outboard side of the input planetary gear set 1018 and coupled to bearings 1032 and 1034 that are coupled to the housing 801 and the input shaft 1004, respectively. The carrier 1022 further includes a downstream section 1036 that is removably coupled to the carrier shafts 1028. The downstream section 1036 is rotationally coupled to the output gear 1010.

The output gear 1010 meshes with an input gear 1056 of a differential 1058. The heat exchanger 904 is further depicted in FIG. 10. The end cover 806 provide efficient access to the electric machine 1000.

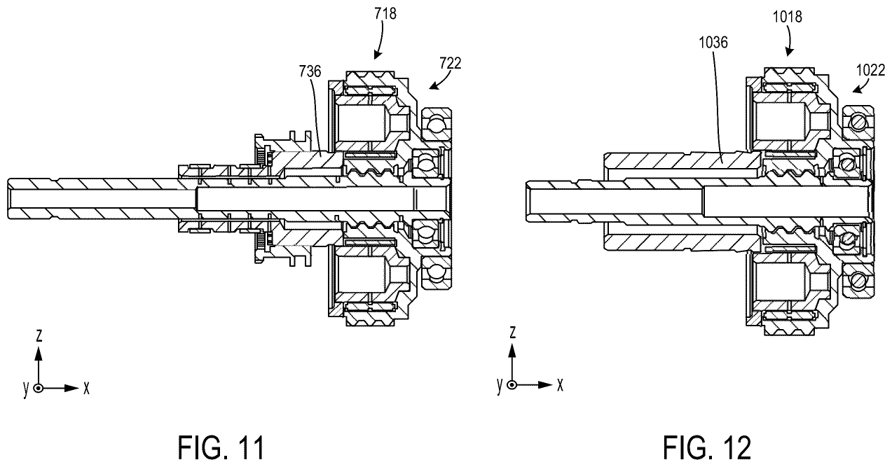

FIGS. 11-12 show detailed views of the input planetary gear sets 718 and 1018. These input planetary gear sets have components that are similar in size and shape aside from the downstream sections 736 and 1036 of the carriers 722 and 1022.

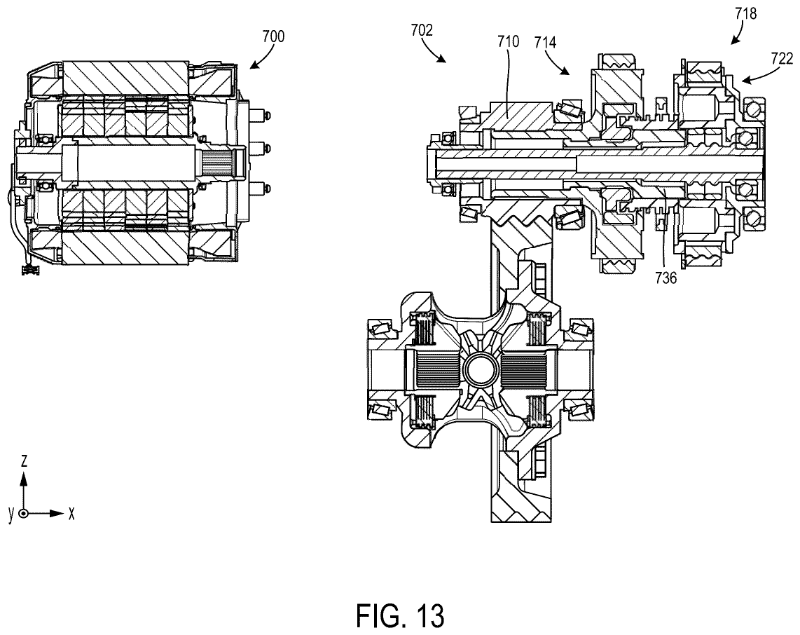

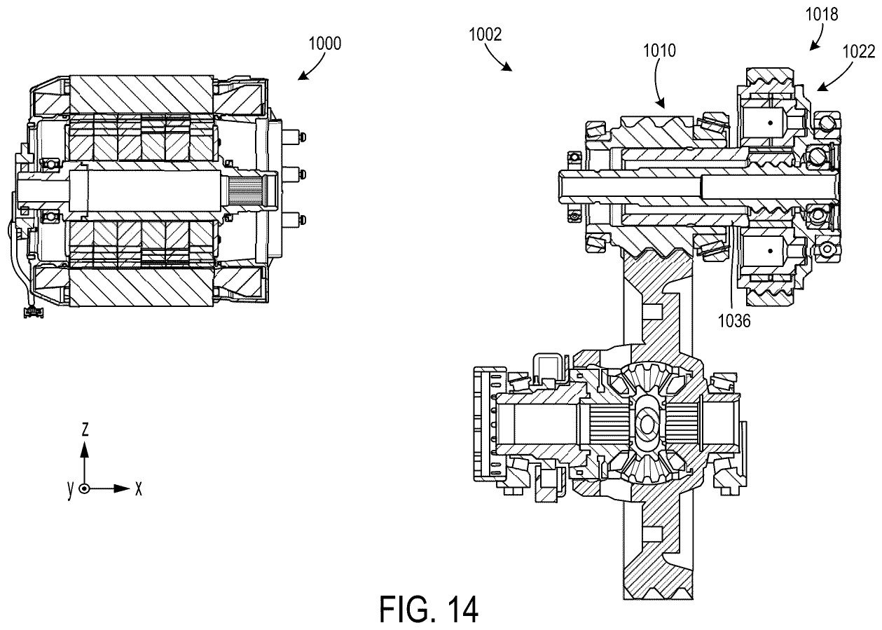

FIGS. 13-14 show different modular electric axle architectures where the traction motors are decoupled from the downstream gear trains. Specifically, different electric machines 700 and 1000 shown in FIGS. 13-14 are identical in size and shape. In this way, parts may be shared between different electric axles to simplify manufacturing. However, the gear train 702 includes the multi-speed planetary gear set 714 and gear train 1002 does not include a multi-speed planetary gear set. However, the output gears 710 and 1010 are similar in size and shape. Further, the input planetary gear sets 718 and 1018 are similar in construction aside from the downstream sections 736 and 1036 of the carriers 722 and 1022 differ in construction to allow for the different electric axle architectures but overlapping parts to be used in the different axle layouts. In this way, multiple combinations of traction motors and gear trains can be combined to customize the design to fit various applications while maintaining part reuse across variants of the designs to reduce manufacturing complexity.

The electric axles described herein may be included in a product line. The product line may be on offer to different customers but the axles in the product line include certain identical parts that are deployed in each of the axles to simplify manufacture and assembly of the different electric axles in the product line.

FIGS. 5-14 are drawn approximately to scale, aside from the schematically depicted components. However, the components may have alternate relative dimensions, in other embodiments.

FIGS. 1-16 show example configurations with relative positioning of the various components. However, the components may have other relative sizes, in other embodiments. It will be appreciated that if shown directly contacting each other, or directly coupled, then such elements may be referred to as directly contacting or directly coupled, respectively, at least in one example. Similarly, elements shown contiguous or adjacent to one another may be referred to as contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Still further in some examples, elements positioned coaxial or parallel to one another may be referred to as such.

The invention is further described in the following paragraphs. In one aspect, an electric axle is provided that comprises a traction motor; an input planetary gear set arranged coaxial to the traction motor and including: a first sun gear rotationally coupled to the traction motor; a first carrier including a first section coupled to multiple carrier shafts and a second section removably coupled to the multiple carrier shafts; and multiple planet gears rotationally mounted on the multiple carrier shafts; and a differential coupled to a downstream component; wherein the differential is positioned parallel to and offset from the traction motor; wherein the second section is rotationally coupled to the downstream component; and wherein the downstream component is arranged coaxial to the input planetary gear set. In one example, the downstream component may be a multi-speed planetary gear set. In another example, the downstream component may be an output gear. In yet another example, the input planetary gear set may be a simple planetary gear set. Further, in another example, a ring gear in the input planetary gear set may be grounded. In yet another example, the differential may be positioned vertically below the traction motor. In another example, the downstream component may be a multi-speed planetary gear set. In another example, the multi-speed planetary gear set may be a simple planetary gear set that may include a clutch configured to: in a first position, rotationally couple the first carrier in the input planetary gear set to a second carrier in the multi-speed planetary gear set; and in a second position, rotationally couple the first carrier in the input planetary gear set to a second sun gear in the multi-speed planetary gear set. In another example, the electric axle may further comprise an inverter coupled to a body of a housing, wherein the body at least partially encloses the input planetary gear set. In another example, the electric axle may further comprise a heat exchanger coupled to the body.

In another aspect, an electric beam axle is provided that comprises a traction motor; an input planetary gear set arranged coaxial to the traction motor and including: a first sun gear rotationally coupled to the traction motor; a first carrier including a first section coupled to multiple carrier shafts and a second section removably coupled to the multiple carrier shafts; a set of planet gears rotationally mounted on the multiple carrier shafts; and a ring gear that meshes with the set of planet gears and is grounded; a downstream component rotationally coupled to the input planetary gear set; and a differential coupled to the downstream component; wherein the differential is positioned parallel to and offset from the traction motor; and wherein the second section is rotationally coupled to a multi-speed planetary gear set or an output gear. In one example, the electric beam axle may further comprise a housing including: a body that at least partially encloses the traction motor; and multiple end covers removably coupled to opposing sides of the body. In another example, the electric beam axle may further comprise a heat exchanger coupled to the housing. In another example, at least one of the heat exchanger may be coupled to a lower side of the body. In another example, the electric beam axle may further comprise an inverter coupled to the body. In another example, the multi-speed planetary gear set may be rotationally coupled to the carrier of the input planetary gear set and the output gear. In another example, the electric beam axle may further comprise a clutch configured to: in a first position, rotationally couple the first carrier in the input planetary gear set to a second sun gear in the multi-speed planetary gear set; and in a second position, rotationally couple the first carrier in the input planetary gear set to a second carrier in the multi-speed planetary gear set.

In another aspect, an electric axle product line is provided that comprises a first electric axle comprising: a first traction motor; and a first input planetary gear set that includes: a first sun gear rotationally coupled to the first traction motor; a first carrier including a first section coupled to multiple carrier shafts and a second section removably coupled to the multiple carrier shafts; and a first set of planet gears rotationally mounted on the multiple carrier shafts; wherein the second section is rotationally coupled to a first downstream component; and a first differential coupled to the first downstream component; wherein the first differential is positioned parallel to and offset from the first traction motor; and a second electric axle comprising: a second traction motor and; a second input planetary gear set that includes: a second sun gear rotationally coupled to the second traction motor; a second carrier including a first section coupled to multiple carrier shafts and a second section removably coupled to the multiple carrier shafts; and multiple planet gears rotationally mounted on the multiple carrier shafts; wherein the second section is rotationally coupled to a second downstream component; and wherein the first section and the multiple carrier shafts in the first carrier are identical to the second section and the multiple carrier shafts in the second carrier; and a second differential coupled to the second downstream component; wherein the second differential is positioned parallel to and offset from the second traction motor. In one example, the first electric axle may comprise a first multi-speed planetary gear set that is rotationally coupled to the first input planetary gear set; the second electric axle may comprise a second multi-speed planetary gear set that is rotationally coupled to the second input planetary gear set; and the first multi-speed planetary gear set and the second multi-speed planetary gear set may be identical in structure and size. In another example, the first multi-speed planetary gear set may be arranged axially between the first traction motor and the first input planetary gear set; and the second input planetary gear set may be arranged axially between the second traction motor and the second multi-speed planetary gear set.

Note that the example control and estimation routines included herein can be used with various powertrain, transmission, and/or vehicle system configurations. The control methods and routines disclosed herein may be stored as executable instructions in non-transitory memory and may be carried out by the control system including the controller in combination with the various sensors, actuators, and other vehicle hardware. Further, the described actions, operations and/or functions may graphically represent code to be programmed into non-transitory memory of the computer readable storage medium in the vehicle control, where the described actions are carried out by executing the instructions in a system including the various hardware components in combination with the electronic controller. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, these specific examples are not to be considered in a limiting sense, because numerous variations are possible. For example, the above technology can be applied to powertrains that include different types of propulsion sources including different types of electric machines and internal combustion engines. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric axle, comprising:
a traction motor;
an input planetary gear set arranged coaxial to the traction motor and including:
a first sun gear rotationally coupled to the traction motor; and
a first carrier including a first section that includes multiple carrier shafts that are each directly coupled to a needle bearing and a second section directly removably coupled to the first section; and
a differential coupled to a downstream component;
wherein the differential is positioned parallel to and offset from the traction motor;
wherein the second section is rotationally coupled to the downstream component;
wherein the downstream component is arranged coaxial to the input planetary gear set;
wherein the input planetary gear set includes multiple planet gears that are directly coupled to the needle bearings; and
wherein the second section of the first carrier is positioned axially outward from the needle bearings in relation to axes of rotation of the needle bearings.

2. The electric axle of claim 1, wherein the downstream component is a multi-speed planetary gear set.

3. The electric axle of claim 1, wherein the downstream component is an output gear.

4. The electric axle of claim 1, wherein the input planetary gear set is a simple planetary gear set.

5. The electric axle of claim 4, wherein a ring gear in the input planetary gear set is grounded.

6. The electric axle of claim 1, wherein the differential is positioned vertically below the traction motor.

7. The electric axle of claim 1, wherein:
the downstream component is a multi-speed planetary gear set; and
the input planetary gear set is positioned axially between the traction motor and the multi-speed planetary gear set.

8. The electric axle of claim 7, wherein the multi-speed planetary gear set is a simple planetary gear set that includes a clutch configured to:
in a first position, rotationally couple the first carrier in the input planetary gear set to a second carrier in the multi-speed planetary gear set; and
in a second position, rotationally couple the first carrier in the input planetary gear set to a second sun gear in the multi-speed planetary gear set.

9. The electric axle of claim 1, further comprising an inverter coupled to a body of a housing, wherein the body at least partially encloses the input planetary gear set.

10. The electric axle of claim 9, further comprising a heat exchanger coupled to the body.

11. An electric beam axle, comprising:
a traction motor;
an input planetary gear set arranged coaxial to the traction motor and including:
a first sun gear rotationally coupled to the traction motor;
a first carrier including a first section that includes multiple carrier shafts that are each directly coupled to a needle bearing and a second section directly removably coupled to the first section; and
a ring gear that meshes with the set of planet gears and is grounded;
a downstream component rotationally coupled to the input planetary gear set; and
a differential coupled to the downstream component;
wherein the differential is positioned parallel to and offset from the traction motor;
wherein the second section is rotationally coupled to a multi-speed planetary gear set or an output gear;
wherein the input planetary gear set includes multiple planet gears that are directly coupled to the needle bearings; and
wherein the second section of the first carrier is positioned axially outward from the needle bearings in relation to axes of rotation of the needle roller bearings.

12. The electric beam axle of claim 11, further comprising a housing including:
a body that at least partially encloses the traction motor; and
multiple end covers removably coupled to opposing sides of the body.

13. The electric beam axle of claim 12, further comprising a heat exchanger coupled to the housing.

14. The electric beam axle of claim 13, wherein at least one of the heat exchanger is coupled to a lower side of the body.

15. The electric beam axle of claim 12, further comprising an inverter coupled to the body.

16. The electric beam axle of claim 11, wherein the multi-speed planetary gear set is rotationally coupled to the carrier of the input planetary gear set and the output gear.

17. The electric beam axle of claim 16, further comprising a clutch configured to:
in a first position, rotationally couple the first carrier in the input planetary gear set to a second sun gear in the multi-speed planetary gear set; and
in a second position, rotationally couple the first carrier in the input planetary gear set to a second carrier in the multi-speed planetary gear set.

18. An electric axle product line, comprising:
a first electric axle comprising:
a first traction motor; and
a first input planetary gear set that includes:
a first sun gear rotationally coupled to the first traction motor;
a first carrier including a first section that includes multiple carrier shafts that are each directly coupled to a needle bearing and a second section directly removably coupled to the first section; and
wherein the second section is rotationally coupled to a first downstream component; and
wherein the first input planetary gear set includes multiple planet gears that are directly coupled to the needle bearings; and
wherein the second section of the first carrier is positioned axially outward from the needle bearings in relation to axes of rotation of the needle bearings;
a first differential coupled to the first downstream component;
wherein the first differential is positioned parallel to and offset from the first traction motor; and
a second electric axle comprising:
a second traction motor; and
a second input planetary gear set that includes:
a second sun gear rotationally coupled to the second traction motor;
a second carrier including a first section that includes multiple carrier shafts that are each directly coupled to a needle bearing and a second section directly removably coupled to the first section;
wherein the second input planetary gear set includes multiple planet gears that are directly coupled to the needle bearings; and
wherein the second section of the second carrier is positioned axially outward from the needle bearings in relation to axes of rotation of the needle bearings;
wherein the second section is rotationally coupled to a second downstream component; and
wherein the first section and the multiple carrier shafts in the first carrier are identical to the second section and the multiple carrier shafts in the second carrier; and
a second differential coupled to the second downstream component;
wherein the second differential is positioned parallel to and offset from the second traction motor.

19. The electric axle product line of claim 18, wherein:
the first electric axle comprises a first multi-speed planetary gear set that is rotationally coupled to the first input planetary gear set;
the second electric axle comprises a second multi-speed planetary gear set that is rotationally coupled to the second input planetary gear set; and
the first multi-speed planetary gear set and the second multi-speed planetary gear set are identical in structure and size.

20. The electric axle product line of claim 19, wherein:
the first multi-speed planetary gear set is arranged axially between the first traction motor and the first input planetary gear set; and
the second input planetary gear set is arranged axially between the second traction motor and the second multi-speed planetary gear set.
